(19) United States
(12) Patent Application Publication
(10) Pub. No.: US 2017/0015011 A1
(43) Pub. Date: Jan. 19, 2017

(54) Apparatus, System, and Method for Transporting and Displaying a Knife

(71) Applicant: Scott Stroh, Erda, UT (US)

(72) Inventor: Scott Stroh, Erda, UT (US)

(21) Appl. No.: 15/213,032

(22) Filed: Jul. 18, 2016

Related U.S. Application Data
(60) Provisional application No. 62/193,716, filed on Jul. 17, 2015.

(51) Int. Cl. B26B 29/02; B26B 1/02

(52) U.S. Cl. CPC B26B 29/025; B26B 1/02

(57) ABSTRACT

An apparatus, system, and method are disclosed for transporting and displaying a knife. The apparatus includes a knife support coupleable to a user's wrist. The knife support has an inner surface positioned opposite an outer surface. The inner surface is positionable adjacent a user's wrist. The outer surface includes a first and second knife receiving recess. The first knife receiving recess is shaped to receive a first end of a knife. The second knife receiving recess is shaped to receive a second end of the knife. The knife support supports the knife in a position to display a profile of the knife when the knife is received within the first knife receiving recess and the second knife receiving recess.

### CROSS-REFERENCES TO RELATED APPLICATIONS

This application claims the benefit of U.S. Provisional Patent Application No. 62/193,716 entitled “APPARATUS, SYSTEM, AND METHOD FOR TRANSPORTING AND DISPLAYING A KNIFE” and filed on Jul. 17, 2015 for Scott Stroh, which is incorporated herein by reference.

### FIELD OF THE INVENTION

This invention relates to knives and more particularly relates to devices for transporting and displaying pocket knives.

### BACKGROUND

A pocket knife is a foldable knife with one or more blades that fit inside the handle that can still fit in a pocket. It is also known as a jackknife or jack-knife. A typical blade length is 5 to 15 centimeters (2 to 6 in). Pocket knives are versatile tools, and may be used for anything from opening an envelope, cutting twine, performing an emergency tracheotomy, slicing a piece of fruit or as a means of self-defense.

The earliest known pocket knives date to at least the early Iron Age. A pocket knife with a bone handle was found at the Hallstatt Culture type site in Austria, dating to around 600-500 BCE. Iberian folding-blade knives made by indigenous artisans and craftsmen and dating to the pre-Roman era have been found in Spain.

Knife collecting is a hobby which includes seeking, locating, acquiring, organizing, cataloging, displaying, storing, and maintaining knives. Knives have been collected by individuals since the 19th century with formal collecting organizations beginning in the 1940s. The custom knife-collecting boom began in the late 1960s and continues to the present

While pocket knives are convenient and useful tools with dedicated collectors owning hundreds if not thousands or more knives, heretofore displaying and storing the pocket knives has been limited to display cases. If a user wishes to transport the knife, the user typically places the pocket knife in his or her pocket to transport the knife. This method of transport has obvious limitations. First, if the user wishes to wear an article of clothing that lacks a pocket, transportation of the knife is difficult. Further, placing the knife in the user's pocket does not allow the user to display the knife. Finally, the knife is difficult to retrieve with the knife in the user's pocket.

### SUMMARY

From the foregoing discussion, it should be apparent that a need exists for an apparatus, system, and method for transporting a knife. Beneficially, such an apparatus, system, and method would allow a user to display the knife during transportation while maintaining easy access to the knife. Accordingly, the present invention has been developed to provide an apparatus, system, and method for transporting and displaying a knife that overcome many or all of the above-discussed shortcomings in the art.

The apparatus to store and display a knife includes a knife support coupleable to a user's wrist. The knife support has an inner surface positioned opposite an outer surface. The inner surface is positionable adjacent a user's wrist. The outer surface includes a first and second knife receiving recess. The first knife receiving recess is shaped to receive a first end of a knife. The second knife receiving recess is shaped to receive a second end of the knife. The knife support supports the knife in a position to display a profile of the knife when the knife is received within the first knife receiving recess and the second knife receiving recess.

In one embodiment, the first knife receiving recess is defined by a first rim that extends substantially perpendicularly from the outer surface of the knife support opposite the inner surface. The second knife receiving recess is also defined by a second rim that extends substantially perpendicularly from the outer surface of the knife support opposite the inner surface. The first rim of the first knife receiving recess and the second rim of the second knife receiving recess limit lateral movement of the knife without limiting movement of the knife in a direction opposite the inner surface. In an exemplary embodiment, a gap is positioned between the first rim and the second rim, the gap is sized to receive a blade of the knife. In such an embodiment, the knife is easily removed by grasping the blade of the knife and prying the knife from within the first and second knife receiving recesses.

The apparatus, in one embodiment, also includes at least one knife retention member that releasably couples the knife to the knife support. In certain embodiments, the knife retention member is a magnet. In an exemplary embodiment, the apparatus includes at least two knife retention members with each knife retention member being magnets. The magnets are magnetically coupleable to the knife to realeably couple the knife to the knife support.

In one embodiment, the apparatus includes a wristband. In certain embodiments, the wristband is pliable. In other embodiments, the wristband is a substantially rigid wristband having a first terminating end, a second terminating end and a gap positioned between the first terminating end and the second terminating end. In such an embodiment, the first knife receiving recess is positioned in the first terminating end and the second knife receiving recess is disposed in the second terminating end.

The wristband, in certain embodiments, includes an inner surface, the inner surface shaped to encircle a palmer portion of a user's wrist. The inner surface extends about the user's wrist in a first direction to engage a first portion of the user's wrist adjacent to a dorsal position of a radius bone of the user's wrist. The inner surface extends about the user's wrist in a second direction (opposite the first direction) to engage a second portion of the user's wrist adjacent to a dorsal position of an ulna bone of the user's wrist.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a description of the subject matter will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1 is a perspective view illustrating one embodiment of a wearable knife storage and display apparatus in accordance with the present subject matter;

FIG. 2 is a perspective view illustrating the wearable knife storage and display apparatus of FIG. 1 positioned on a user's wrist in accordance with one embodiment of the present subject matter; and

FIG. 3 is a perspective view illustrating another embodiment of a wearable knife storage and display apparatus in accordance with the present subject matter.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided for a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

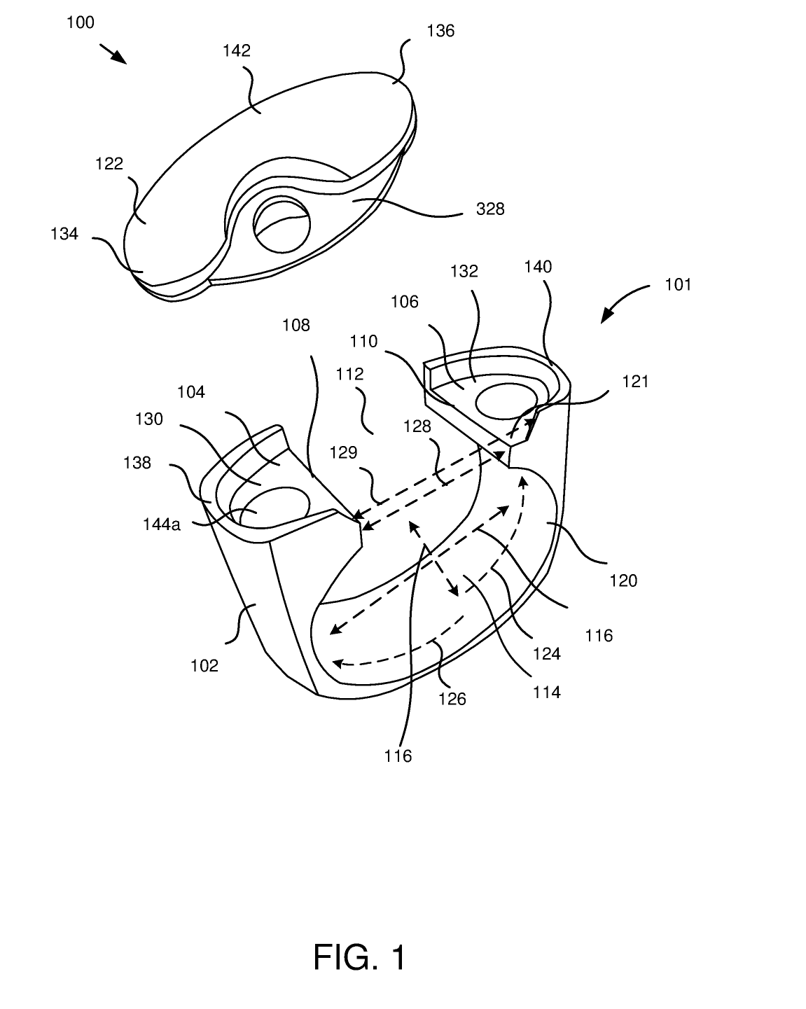

FIG. 1 is a perspective view illustrating one embodiment of a wearable knife storage and display apparatus 100 in accordance with the present subject matter. In certain embodiments, the apparatus 100 includes a knife support 101 coupleable to a user's wrist. In the embodiment illustrated in FIG. 1, the knife support 101 is a substantially rigid wristband 102 which includes, a first knife receiving recess 104 and a second knife receiving recess 106. As discussed below, the first knife receiving recess 104 and the second knife receiving recess 106 are sized and shaped to receive a knife 122 to securely store and display the knife 122.

One of skill in the art will recognize that knives 122 are often decorated ornately. In such embodiments, the owners of such knives may wish to display the knives 122. Accordingly, in an exemplary embodiment, the knife support 101 (i.e., the wristband 102) supports the knife 122 in a position to display a top surface 142 of the knife 122 when the knife 122 is received within the first knife receiving recess 104 and the second knife receiving recess 106. In one embodiment, the knife support 101 is configured to display the entire top surface 142 of the knife 122 when the knife 122 is received within the first knife receiving recess 104 and the second knife receiving recess 106.

The wristband 102, in one embodiment, includes a first terminating end 108 and a second terminating end 110. In an exemplary embodiment, the wristband 102 is semi-tubular to encircle at least a portion of the user's wrist. In such an embodiment, the substantially rigid wristband 102 includes a gap 112 between the first terminating end 108 and the second terminating end 110 which allows a user to position his or her wrist through the gap 112 and into a wrist receiving space 114 within the wristband 102.

The wrist receiving space 114, in certain embodiments, has a width 116 that is substantially greater than a height 118. One of skill in the art will recognize that a typical user's wrist has a greater width than height. By having a wrist receiving space 114 that has a width 116 that is substantially greater than a height 118, the user's wrist can be comfortably placed within the wrist receiving space 114.

To allow a user to position his or her wrist within the wrist receiving space 114, the gap 112 has a width 128 that is at least as long as a height of the user's wrist. In certain embodiments, to position the user's wrist within the wrist receiving space 114, the user slides his or her wrist through the gap 112 in the wristband 102 with the wristband 102 positioned such that the height of the user's wrist fits through the gap 112 in the wristband 102.

An inner surface 120 of the wristband 102 is shaped to encircle a palmer portion of a user's wrist. One of skill in the art will recognize that the palmer portion of a user's wrist is the portion of the user's wrist on the palm side of the user's hand. The inner surface 120 of the wristband 102 extends about the user's wrist in a first direction 124 to engage a first portion of the user's wrist adjacent to a dorsal position of a radius bone of the user's wrist. The inner surface 120 of the wristband 102 extends about the user's wrist in a second direction 124 to engage a second portion of the user's wrist adjacent to a dorsal position of an ulna bone of the user's wrist. One of skill in the art will recognize that the dorsal position of a user's wrist is the portion of the user's wrist opposite the palm side of the user's hand.

Once the user has positioned his or her wrist through the gap 112 and into the wrist receiving space 114, the wristband 102 is rotated to engage the first portion of the user's wrist adjacent to the dorsal position of the radius bone and to engage the second portion of the user's wrist adjacent to a dorsal position of an ulna bone of the user's wrist. As discussed above, a typical user's wrist has a greater width than height. Accordingly, once the user's wrist is positioned within the wrist receiving space 114 and the wristband 102 is rotated, the first terminating end 108 and the second terminating end 110 engage the dorsal position of the user's wrist to keep the user's wrist positioned within the wrist receiving space 114.

As is evident to one of skill in the art, dimensions of a user's wrist vary from individual to individual. Accordingly, in certain embodiments, the size of the gap 112 and the wrist receiving space 114 may be varied to accommodate a particular individual's anatomy.

In one embodiment, the first knife receiving recess 104 is disposed in an outer surface 130 of the first terminating end 108 of the wristband 102. Similarly, the second knife receiving recess 106 is disposed in an outer surface 132 of the second terminating end 110 of the wristband 102. The first and second knife receiving recesses 104 and 106 are shaped to receive opposing ends of a knife 122. Thus, the first knife receiving recess 104 is shaped to receive a first end 134 of the knife 122 and the second knife receiving recess 106 is shaped to receive a second end 136 of the knife 122.

Each of the first and second knife receiving recesses 104 and 106 are defined by rims 138 and 140 respectively. The first rim 138 extends about the first knife receiving recess 104 and the second rim 140 extends about the second knife receiving recess 106. Each rim 138 and 140 extends substantially perpendicularly from an outer surface 121 of the knife support 101 in a direction opposite the inner surface 120 of the knife support 101. With the knife 122 positioned within the first and second knife receiving recesses 104 and 106, the first rim 138 of the first knife receiving recess 104 and the second rim 140 of the second knife receiving recess 106 limit lateral and/or rotational movement of the knife 122 without limiting movement of the knife 122 in a direction opposite the inner surface 120. In one embodiment, the first rim 138 of the first knife receiving recess 104 is separated from the second rim 140 of the second knife receiving recess 106 by a gap 129. The gap 129 between the first rim 138 of the first knife receiving recess 104 and the second rim 140 of the second knife receiving recess 106 is sized to receive a blade 328 of the knife 122. This allows the knife 122 to be easily removed from within the first and second knife receiving recesses 104 and 106 by grasping the blade 328 of the knife 122 and prying the knife 122 out of the first and second knife receiving recesses 104 and 106.

In the embodiment illustrated in FIG. 1, the first and second rims 138 and 140 are arched to mimic the arches on the first and second ends 134 and 136 of the knife 122. One of skill in the art will recognize that in other embodiments, the knife may include ends 134 and 136 that have other geometric shapes. In such embodiments, the first and second rims 138 and 140 may be altered to accommodate the other geometric shapes comprising the first and second ends 134 and 136 of the alternatively shaped knife 122.

When the knife 122 is positioned within the first and second knife receiving recesses 104 and 106, the knife 122 spans the gap 112 between the first terminating end 108 and the second terminating end 110 of the wristband 102. Thus, with the first and second ends 134 and 136 of the knife 122 positioned within the first and second knife receiving recesses 104 and 106, the user's wrist is entirely encircled providing an aesthetically pleasing manner in which to transport and display the user's knife 122. Furthermore, with the knife 122 stored in such a manner, the user's hands are left free to perform other tasks while still having convenient and easy access to the knife 122.

In certain embodiments, the apparatus 100 includes at least one knife retention member configured to releasably couple the knife 122 to the wristband 102. For example, in one embodiment the rims 138 and 140 may include a lip or other knife retention member (not shown). In such an embodiment, the lip or other knife retention member may be configured to releasably engage a top surface 142 of the knife 122 once the knife 122 has been positioned within the first and second knife receiving recesses 104 and 106.

In the embodiment illustrated in FIG. 1, the knife retention member comprises a first magnet 144a and a second magnet 144b (collectively magnets 144 or knife retention members 144). The magnets 144 are magnetically coupleable to the knife 122 to releasably couple the knife 122 to the wristband 102. In other embodiments, a greater or lesser number of magnets 144 may be used to releasably couple the knife 122 to the wristband 102.

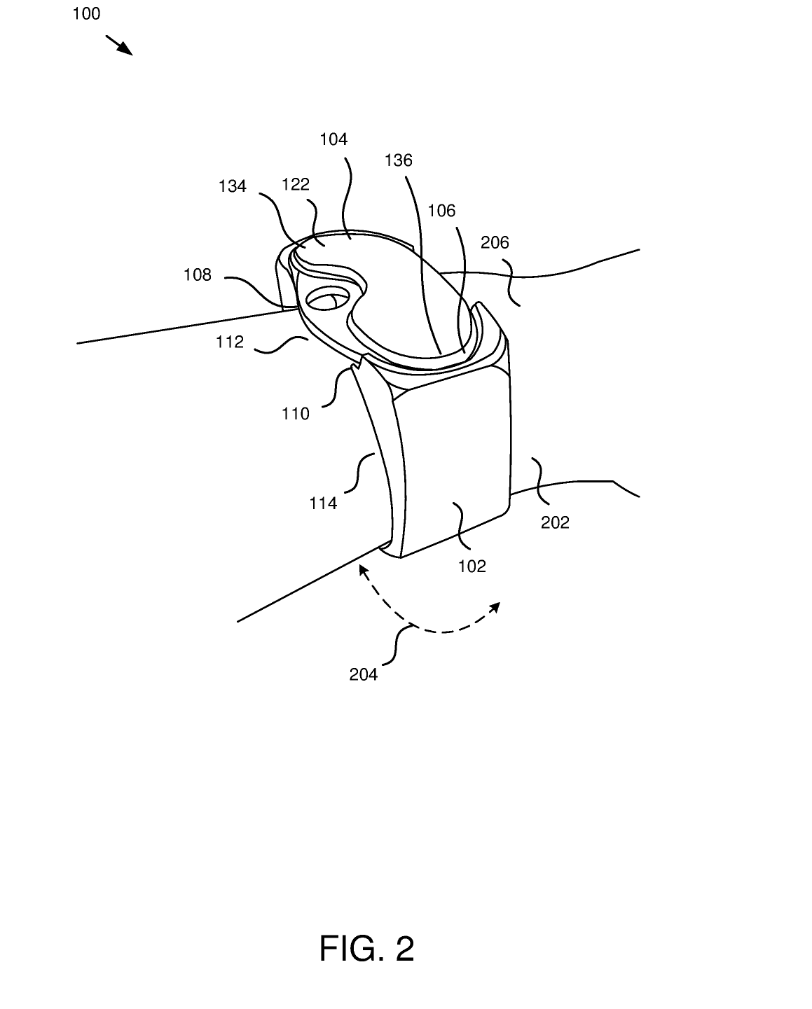

FIG. 2 is a perspective view illustrating the wearable knife storage and display apparatus 100 of FIG. 1 positioned on a user's wrist 202 in accordance with one embodiment of the present subject matter. In the embodiment depicted in FIG. 2, the user's wrist 202 has been positioned through the gap 112 and into the wrist receiving space 114.

With the user's wrist 202 positioned within the wrist receiving space 114, the wristband 102 is rotated in either direction as indicated by arrow 204 to position the gap on the dorsal portion 206 of the user's wrist 202. The knife 122 is then positioned within the first and second knife receiving recesses 104 and 106 such that the knife 122 spans the gap 112 between the first terminating end 108 and the second terminating end 110 of the wristband 102. Accordingly, as discussed above, with the first and second ends 134 and 136 of the knife 122 positioned within the first and second knife receiving recesses 104 and 106, the user's wrist is entirely encircled providing a convenient and aesthetically pleasing manner in which to transport and display the user's knife 122.

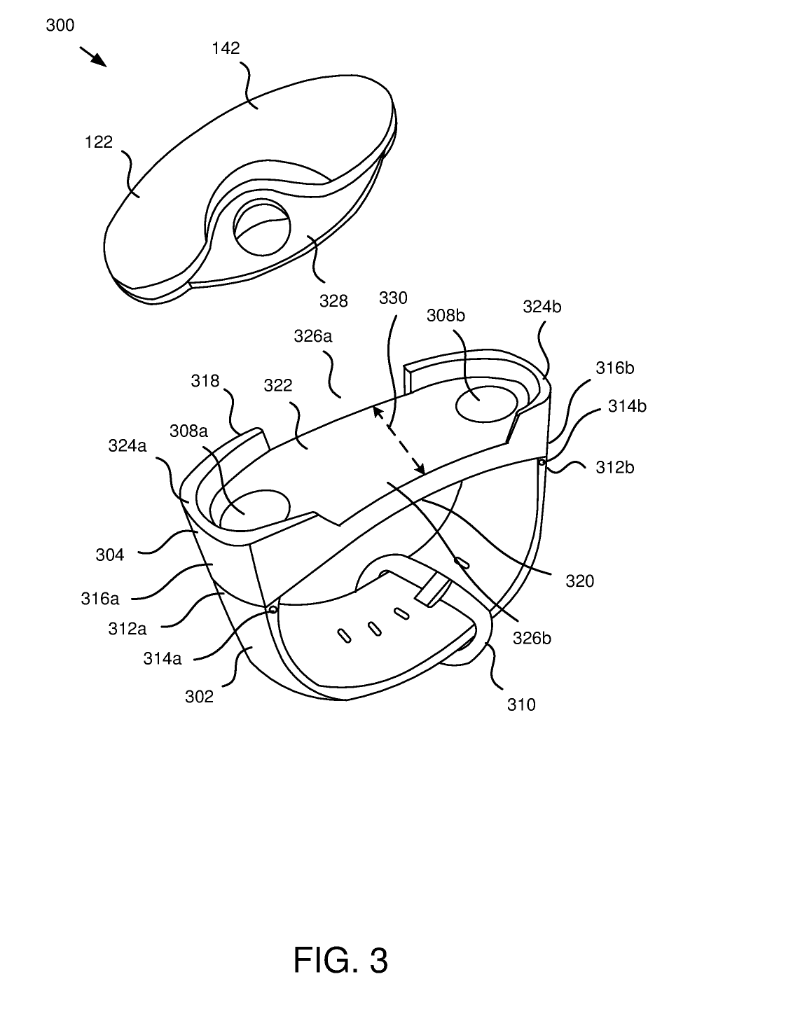

FIG. 3 is a perspective view illustrating another embodiment of a wearable knife storage and display apparatus 300 in accordance with the present subject matter. The apparatus 300, in certain embodiments, includes a wristband 302, a knife receiving plate 304, a recess 306 disposed in the knife receiving plate 304 and at least one knife retention member 308a and 308b (collectively knife retention members 308).

The wristband 302, in one embodiment, comprises a pliable material for encircling at least a portion of a user's wrist 202. The wristband comprises a may be made of any material conventionally used in coupling a watch to a user's wrist 202. In the embodiment illustrated in FIG. 3, the wristband 302 includes a buckle 310 for adjusting a size of the wristband 302 as is known in the art. In other embodiments, other adjustment members (i.e., clasps, hook-and-loop fasteners, etc.) may be incorporated to allow the size of the wristband 302 to be adjusted to accommodate a user's anatomy.

The knife receiving plate 304 is coupled to opposing ends 312a and 312b of the wristband 302. In the embodiment illustrated in FIG. 3, the opposing ends 312a and 312b of the wristband 302 are removably coupled to the wristband 302 with pins 314a and 314b. The pins 314a and 314b extend through at least a portion of the opposing ends 312a and 312b respectively and through at least a portion of opposing ends 316a and 316b respectively of the knife receiving plate 304 to removably couple the wristband 302 to the knife receiving plate 304.

In other embodiments, the knife receiving plate 304 may be permanently affixed to the wristband 302. One of skill in the art will recognize alternative ways of coupling the knife receiving plate 304 to the wristband 302.

The knife receiving plate 304 includes an outer surface 318 disposed opposite an inner surface 320. The inner surface 320, in certain embodiments, is curved to accommodate the dorsal portion 206 of the user's wrist 202. The outer surface 318 includes a knife receiving recess 322. The knife receiving recess 322 is sized and shaped to receive the knife 122.

In certain embodiments, the knife receiving recess 322 is defined by rims 324a and 324b that extend about the opposing ends 316a and 316b respectively of the knife receiving plate 304. The rims 324a and 324b facilitate maintaining the knife positioned within the knife receiving recess 322. In one embodiment, the rims 324a and 324b completely encircle the outer surface 318 of the knife receiving plate 304 and are shaped substantially similar to the shape of the knife 122.

In other embodiments, one or more blade gaps 326a and 326b are disposed between the rims 324a and 324b. In such an embodiment, the blade gaps 326a and 326b are sized to accommodate the blade 328 of the knife 122. By including blade gaps 326a and 326b, the width of the knife receiving plate 304 may be reduced allowing for a lighter and more comfortable fit of the knife receiving plate 304 on the dorsal portion 206 of the user's wrist 202.

In the embodiment illustrated in FIG. 3, the knife receiving plate 304 includes two blade gaps 326a and 326b. This allows the knife 122 to be flipped over to display whichever side of the knife 122 that the user finds most appealing. In other embodiments, the knife receiving plate 304 may include a single blade gap 326a or 326b.

The rims 324a and 324b, in one embodiment, may include a lip or other knife retention member (not shown). In such an embodiment, the lip or other knife retention member may be configured to releasably engage the top surface 142 of the knife 122 once the knife 122 has been positioned within the knife receiving recess 322 in the outer surface 318 of the knife receiving plate 304.

In the embodiment illustrated in FIG. 3, the knife retention members 308a and 308b comprise magnets. Each magnet is positioned at opposing ends of the knife receiving recess 322. The magnets are magnetically coupleable to the knife 122 to releasably couple the knife 122 to the knife receiving plate 304. In other embodiments, a greater or lesser number of magnets may be used to releasably couple the knife 122 to the knife receiving plate 304.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A wearable knife storage and display apparatus, the apparatus comprising:
a knife support coupleable to a user's wrist, the knife support comprising an inner surface disposed opposite an outer surface, the inner surface positionable adjacent a user's wrist;
a first knife receiving recess disposed in the outer surface of the knife support, the first knife receiving recess shaped to receive a first end of a knife; and
a second knife receiving recess disposed in the outer surface of the knife support, the second knife receiving recess shaped to receive a second end of the knife, wherein the knife support supports the knife in a position to display a profile of the knife when the knife is received within the first knife receiving recess and the second knife receiving recess.

2. The apparatus of claim 1, further comprising at least one knife retention member, the at least one knife retention member releasably coupling the knife to the knife support.

3. The apparatus of claim 2, wherein the at least one knife retention member comprises a magnet.

4. The apparatus of claim 2, wherein the at least one knife retention member comprises at least two knife retention members.

5. The apparatus of claim 4, wherein the at least two retention members comprise at least two magnets, wherein the at least two magnets are magnetically coupleable to the knife to realeably couple the knife to the knife support.

6. The apparatus of claim 1, further comprising a substantially rigid wristband, the wristband comprising a first terminating end, a second terminating end and a gap disposed between the first terminating end and the second terminating end, wherein the first knife receiving recess is disposed in the first terminating end and wherein the second knife receiving recess is disposed in the second terminating end.

7. The apparatus of claim 6, wherein the wristband further comprises an inner surface, the inner surface shaped to encircle a palmer portion of a user's wrist, wherein the inner surface extends about the user's wrist in a first direction to engage a first portion of the user's wrist adjacent to a dorsal position of a radius bone of the user's wrist and wherein the inner surface extends about the user's wrist in a second direction to engage a second portion of the user's wrist adjacent to a dorsal position of an ulna bone of the user's wrist.

8. The apparatus of claim 1, wherein the first knife receiving recess is defined by a first rim extending substantially perpendicularly from the outer surface opposite the inner surface.

9. The apparatus of claim 8, wherein the second knife receiving recess is defined by a second rim extending substantially perpendicularly from the outer surface opposite the inner surface.

10. The apparatus of claim 9, further comprising a gap disposed between the first rim and the second rim, the gap sized to receive a blade of the knife.

11. The apparatus of claim 9, wherein the first rim of the first knife receiving recess and the second rim of the second knife receiving recess limit lateral movement of the knife without limiting movement of the knife in a direction opposite the inner surface.

12. A wearable knife storage and display apparatus, the apparatus comprising:
a knife support coupleable to a user's wrist, the knife support comprising an inner surface disposed opposite an outer surface, the inner surface comprising a surface positionable adjacent a user's wrist;
a first knife receiving recess disposed in the outer surface of the knife support, the first knife receiving recess shaped to receive a first end of a knife;
a second knife receiving recess disposed in the outer surface of the knife support, the second knife receiving recess shaped to receive a second end of the knife, wherein the knife support supports the knife in a position to display a profile of the knife when the knife is received within the first knife receiving recess and the second knife receiving recess; and
at least one magnet magnetically coupleable to the knife to couple the knife to the knife support.

13. The apparatus of claim 12, wherein the first knife receiving recess is defined by a first rim extending substantially perpendicularly from the outer surface opposite the inner surface and wherein the second knife receiving recess is defined by a second rim extending substantially perpendicularly from the outer surface opposite the inner surface.

14. The apparatus of claim 13, wherein the first rim of the first knife receiving recess and the second rim of the second knife receiving recess limit lateral movement of the knife without limiting movement of the knife in a direction opposite the inner surface.

15. A wearable knife storage and display apparatus, the apparatus comprising:
a wristband configured to encircle at least a portion of a user's wrist;
a knife support coupled to the wristband;
a first knife receiving recess disposed in a outer surface of the knife support, the first knife receiving recess shaped to receive a first end of a knife;
a second knife receiving recess disposed in the outer surface of the knife support, the second knife receiving recess shaped to receive a second end of the knife, wherein the knife support supports the knife in a position to display a profile of the knife when the knife is received within the first knife receiving recess and the second knife receiving recess; and
at least one knife retention member, the at least one knife retention member releasably coupleable to the knife.

16. The apparatus of claim 15, wherein the at least one knife retention member comprises a magnet.

17. The apparatus of claim 15, wherein the at least one knife retention member comprises at least two magnets, each magnet positioned in one of the first knife receiving recess and the second knife receiving recess, wherein the at least two magnets are magnetically coupleable to the knife to realeably couple the knife to the knife support.

18. The apparatus of claim 15, wherein the wristband comprises a pliable material.

19. The apparatus of claim 15, wherein the wristband comprises a substantially rigid wristband having a first terminating end, a second terminating end and a gap disposed between the first terminating end and the second terminating end, wherein the first knife receiving recess is disposed in the first terminating end and wherein the second knife receiving recess is disposed in the second terminating end.

20. The apparatus of claim 15, wherein the first knife receiving recess is defined by a first rim extending substantially perpendicularly from the outer surface opposite the inner surface and wherein the second knife receiving recess is defined by a second rim extending substantially perpendicularly from the outer surface opposite the inner surface, wherein the first rim of the first knife receiving recess and the second rim of the second knife receiving recess limit lateral movement of the knife without limiting movement of the knife in a direction opposite the inner surface.
